(19) United States
(12) Patent Application Publication
(10) Pub. No.: US 2007/0218177 A1
(43) Pub. Date: Sep. 20, 2007

(54) Flavor composition and method of adding flavor to prepared foods

(76) Inventor: Sean Pomper, North Woodmere, NY (US)

Correspondence Address: AMSTER, ROTHSTEIN & EBENSTEIN LLP, 90 PARK AVENUE, NEW YORK, NY, 10016, US

(21) Appl. No.: 11/378,490

(22) Filed: Mar. 16, 2006

(51) Int. Cl. A23L 1/22

(52) U.S. Cl. 426/534

(57) ABSTRACT

A liquid flavor composition used to add flavor to prepared foods includes water, salt, a preservative and flavoring present in an amount of at least 8% by weight.

### TECHNICAL FIELD

The present invention is generally related to flavoring compositions and, more particularly, flavoring compositions that are dispersed onto prepared foods.

### BACKGROUND

As modem society becomes increasingly health-conscious, more attention is being paid to the ingredients of prepared foods. People are often encouraged for health-related reasons to forego food items that have relatively high concentrations of potentially harmful ingredients, such as fat, cholesterol and salt and/or that provide excessive amounts of calories and carbohydrates. Unfortunately, as most of us are well aware, the most “unhealthy” food ingredients are typically the most pleasing to the palate. For example, butter, bacon and sweet chocolate are culinary favorites, but these food items are typically sworn off because of their common association with afflictions such as heart disease, obesity and diabetes.

Prepared food manufacturers often use flavorings in their products to reduce manufacturing costs, increase product appeal to the health-conscious consumer and/or enhance the overall taste of the product. Flavorings can be either natural or artificial. There are also so-called “nature identical” flavorings, which are the chemical equivalent of natural flavors, only chemically synthesized rather than being extracted from the original source.

Although these flavorings are available to food manufacturers, with the exception of butter-flavored sprays, there is no product currently available to the individual consumer that allows for the addition of a wide variety of flavors to prepared foods. Accordingly, there is a need for a flavor composition that can be easily applied to prepared foods to deliver a wide variety of flavors as a substitute for potentially unhealthy prepared food ingredients.

### SUMMARY OF THE INVENTION

A method of adding flavor to a prepared food according to an exemplary embodiment of the present invention includes the steps of: preparing a liquid flavor composition including flavoring present in an amount of at least 8% by weight; and dispersing the liquid flavor composition onto the prepared food.

In at least one embodiment, the flavoring is present in an amount of 15% by weight.

In at least one embodiment, the step of dispersing includes spraying the liquid flavor mixture from a spray bottle or an aerosol container.

A liquid flavor composition used to add flavor to prepared foods according to an exemplary embodiment of the present invention includes water, salt, a preservative and flavoring present in an amount of at least 8% by weight.

These and other features of this invention are described in, or are apparent from, the following detailed description of various exemplary embodiments of this invention.

### DETAILED DESCRIPTION OF PREFERRED EMBODIMENTS

The flavor composition of the present invention provides flavor to prepared foods without adding calories, carbohydrates, fat or cholesterol. Depending on the specific flavoring added to the flavor composition, the flavor composition can act as a substitute for certain ingredients typically added to prepared food. For example, for users on a diet plan, the flavor composition of the present invention can be used in place of toppings, gravies, dressings and sauces, which typically are the most fattening items added to prepared foods. Since the flavor composition of the present invention contains zero calories, zero fat, zero cholesterol and zero carbohydrates, the dieting user can enjoy the same tastes without feeling guilty about breaking the diet regimen.

The flavor composition according to an exemplary embodiment of the present invention includes water, salt, a preservative and flavoring. The preservative is preferably sodium benzoate, although any other suitable preservative may be used, such as, for example, sodium nitrate, sodium nitrite and sulfites. The flavoring may be any suitable flavoring depending on the desired overall flavor of the composition. For example, the flavoring may be any one of the following flavorings: parmesan cheese, butter, pesto, tomato basil, bacon, carmalized onion, ketchup, bleu cheese, cheddar cheese, hot and sour, barbeque, teriyaki, banana split, chocolate, marshmallow, coffee, mango, pineapple, kiwi and blueberry. These flavorings are available from proprietary flavoring manufacturers, such as Mastertaste of Teterboro, N.J.

In a preferred embodiment, the flavoring is bacon flavoring. Table 1 below shows the ingredients and amount of each ingredient in bacon flavoring according to an exemplary embodiment of the present invention.

TABLE 1
Ingredients of Bacon Flavoring

| | AMOUNT |
|---|---|
| INGREDIENT | (% by weight) |
| autolyzed yeast extract | <50 |
| citric acid | 10-25 |
| salt | 1-10 |
| dried yeast | 1-10 |
| maltodextrin | 1-10 |
| xanthan gum | 1-10 |
| traicetin | <1 |
| natural flavor (e.g., bacon) | <1 |
| sunflower oil | <1 |

In the overall flavor composition according to an exemplary embodiment of the present invention, salt is present in a preferred amount of 12.78% by weight, water is present in a preferred amount of 72.12% by weight, preservative is present in a preferred amount of 0.10% by weight and flavoring is present in a preferred amount of 15%. It should be appreciated that these amounts can be modified to adjust the intensity of the flavoring composition. In particular, the amount of flavoring can be reduced to lessen the intensity of the flavor composition or the amount of flavoring can be increased to heighten the intensity of the flavor composition. Preferably, the flavoring in accordance with the composition shown in Table 1 is present in the flavor composition in an amount of between 8% by weight and 15% by weight. Relatively high amounts of flavoring are preferred so that only a small amount of flavor composition is required to flavor a food item.

The flavor composition can be delivered to a prepared food item by any suitable means. Preferably, since the flavor composition of the present invention contains a high concentration of flavoring, a relatively small amount of flavor composition is evenly dispersed over a food item. Thus, in preferred embodiments, the flavor composition is sprayed onto the food item using any suitable spray means, such as, for example, a spray bottle or an aerosol container.

In a preferred method of preparing the flavor composition according to an exemplary embodiment of the present invention, a brine is first prepared by mixing the water with a preservative (sodium benzoate) until dissolved, and then the salt is mixed in until dissolved. The flavoring is then blended for a period of approximately 2 minutes, or until the flavoring is fully dispersed within the mixture. The flavoring may be blended with a high shear mixture at 500 RPM.

Now that the preferred embodiments have been shown and described in detail, various modifications and improvements thereon will be readily apparent to those skilled in the art. Accordingly, the spirit and scope of the present invention is to be construed broadly and be limited only by the appended claims, and not by the foregoing specification.

What is claimed is:

1. A method of adding flavor to a prepared food comprising:
preparing a liquid flavor composition comprising flavoring present in an amount of at least 8% by weight; and
dispersing the liquid flavor composition onto the prepared food.

2. The method of claim 1, wherein the liquid flavor composition further comprises water, salt and a preservative.

3. The method of claim 1, wherein the flavoring is present in an amount of 15% by weight.

4. The method of claim 3, wherein the liquid flavor composition comprises water present in an amount of about 72.12% by weight, salt present in an amount of about 12.78% by weight and preservative present in an amount of about 0.10% by weight.

5. The method of claim 2, wherein the preservative is sodium benzoate.

6. The method of claim 1, wherein the flavoring is bacon flavoring.

7. The method of claim 1, wherein the step of dispersing comprises spraying the liquid flavor composition from a spray bottle or an aerosol container.

8. A liquid flavor composition used to add flavor to prepared foods, comprising:
water;
salt;
a preservative; and
flavoring present in an amount of at least 8% by weight.

9. The liquid flavor composition of claim 8, wherein the flavoring is present in an amount of 15% by weight.

10. The liquid flavor composition of claim 9, wherein water is present in an amount of about 72.12% by weight, salt is present in an amount of about 12.78% by weight and preservative is present in an amount of about 0.10% by weight.

11. The liquid flavor composition of claim 8, wherein the flavoring is bacon flavoring.

12. The liquid flavor composition of claim 8, wherein the preservative is sodium benzoate.
